(19) United States
(12) Patent Application Publication
(10) Pub. No.: US 2019/0106057 A1
(43) Pub. Date: Apr. 11, 2019

(54) REARVIEW MIRROR ASSEMBLY INCORPORATING INTEGRATED ELECTRONIC DEVICE HOLDER

(71) Applicant: FORD GLOBAL TECHNOLOGIES, LLC, Dearborn, MI (US)

(72) Inventors: Victor Christian Jaime Tamayo, Mexico City (MX); Kevin Amper Ajzen, Huixquilucan (MX); Mario Alejandro Garrido Escareno, Mexico City (MX); David Delgado Andrade, Alvaro Obregon (MX)

(21) Appl. No.: 15/728,291

(22) Filed: Oct. 9, 2017

(51) Int. Cl. B60R 1/12; B60R 1/04; B60R 11/02; B60R 16/02

(52) U.S. Cl. CPC B60R 1/12; B60R 1/04; B60R 2011/0033; B60R 16/02; B60R 2001/1292; B60R 11/0241

(57) ABSTRACT

A rearview mirror assembly includes a housing, a mirror carried on the housing and a clamping element carried on the housing. The clamping element is displaceable between a stowed position at least partially concealed within the housing and a deployed position at least partially projecting from the housing. An electronic device may be held in the deployed clamping element below the mirror for easy viewing.

### TECHNICAL FIELD

This document relates generally to the motor vehicle equipment field and, more particularly, to a rearview mirror assembly that incorporates a clamping element which functions as an electronic device holder.

### BACKGROUND

Current motor vehicles may be equipped with an electronic device holder located on the vehicle's center console or along the windshield at the top of the instrument panel. Such an electronic device holder holds an electronic device such as a smart phone which may be used, for example, to display a map for navigation purposes.

Fixed electronic device holders of this type occupy space when not in use and are often unsightly. Further, the electronic device holders are usually positioned and require the driver of the motor vehicle to divert his sight line from the road in order to view the display screen of the electronic device. In addition, the motor vehicle USB port is commonly provided at a location remote from the electronic device holder thereby requiring the use of a relatively long cable in order to charge the electronic device during use. Such a long cable can interfere with other objects in the cabin causing driver distraction.

This document relates to a new and improved rearview mirror assembly that incorporates an integral electronic device holder that addresses and resolves the disadvantages noted above characteristic of prior art electronic device holders.

### SUMMARY

In accordance with the purposes and benefits described herein, a new and improved rearview mirror assembly is provided. That new and improved rearview mirror assembly includes an integral electronic device holder adapted to hold an electronic device adjacent the sight line used by the driver when operating the motor vehicle so as to minimize distraction when viewing the display screen of the electronic device. The rearview mirror assembly includes a housing, a mirror carried on the housing and a clamping element carried on the housing. The clamping element is displaceable between a stowed position, wherein the clamping device is at least partially concealed within the housing behind the mirror, and a deployed position at least partially projecting from the housing.

The rearview mirror assembly may further include a guideway carried on the housing. That guideway may include a first guide track and a second guide track. The clamping element may include a cradle, a first support and a second support. The first support may slide along the first guide track while the second support may slide along the second guide track.

The rearview mirror assembly may further include a biasing feature adapted to bias the clamping element toward the stowed position. That biasing feature may comprise a first tension spring and a second tension spring. The first tension spring may be received over the first guide track while the second tension spring may be received over the second guide track. Further, the first tension spring may have a first end secured to the first guide track and a second end secured to the first support. The second tension spring may have a third end secured to the second guide track and fourth end secured to the second support.

The rearview mirror assembly may also include a USB port. That USB port may be carried on the housing. Such a USB port is located adjacent the electronic device when held in the cradle of the rearview mirror assembly. This allows a very short cable to be utilized to connect the electronic device to the USB port and thereby allow charging. Such a short cable is not distracting and does not interfere with operation of the motor vehicle in any manner.

In the following description, there are shown and described several preferred embodiments of the rearview mirror assembly. As it should be realized, the rearview mirror assembly is capable of other, different embodiments and its several details are capable of modification in various, obvious aspects all without departing from the rearview mirror assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the rearview mirror assembly and together with the description serve to explain certain principles thereof.

FIG. 1 is a perspective view of the rearview mirror assembly illustrating the clamping element/cradle in the deployed position with a smart phone held in the cradle under the mirror.

FIG. 2 is a side elevational view of the structure illustrated in FIG. 1.

FIG. 3 is a front elevational view of the rearview mirror assembly illustrating the clamping element/cradle in the deployed position.

FIG. 4 is a detailed side elevational view of the rearview mirror assembly illustrating the clamping element/cradle in the stowed position at least partially concealed within the housing of the rearview mirror.

Reference will now be made in detail to the present preferred embodiments of the rearview mirror assembly, examples of which are illustrated in the accompanying drawing figures.

### DETAILED DESCRIPTION

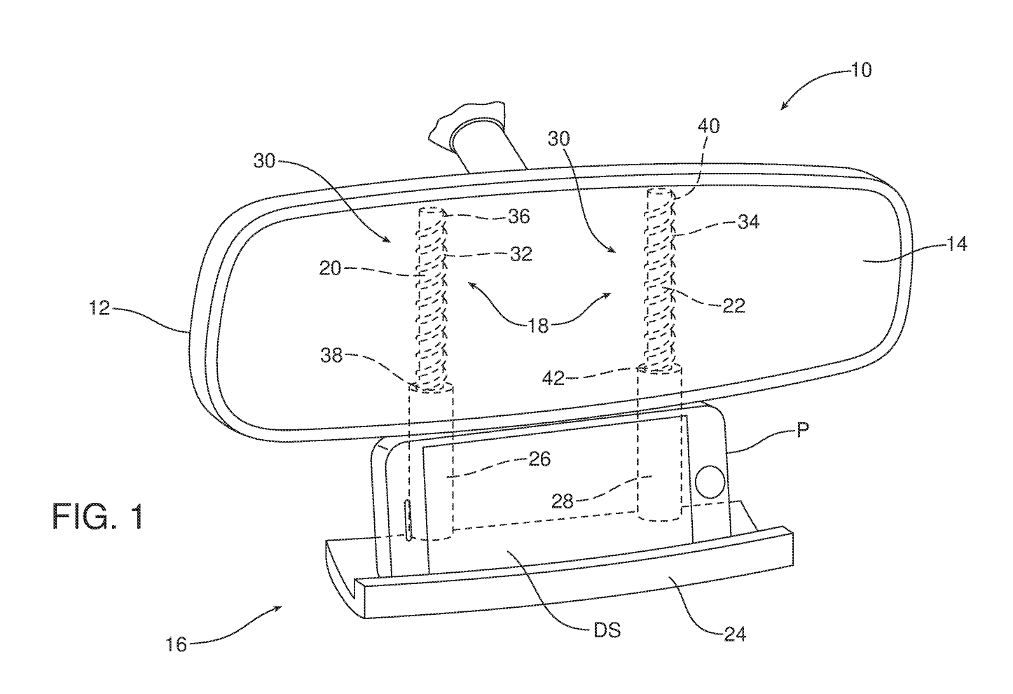

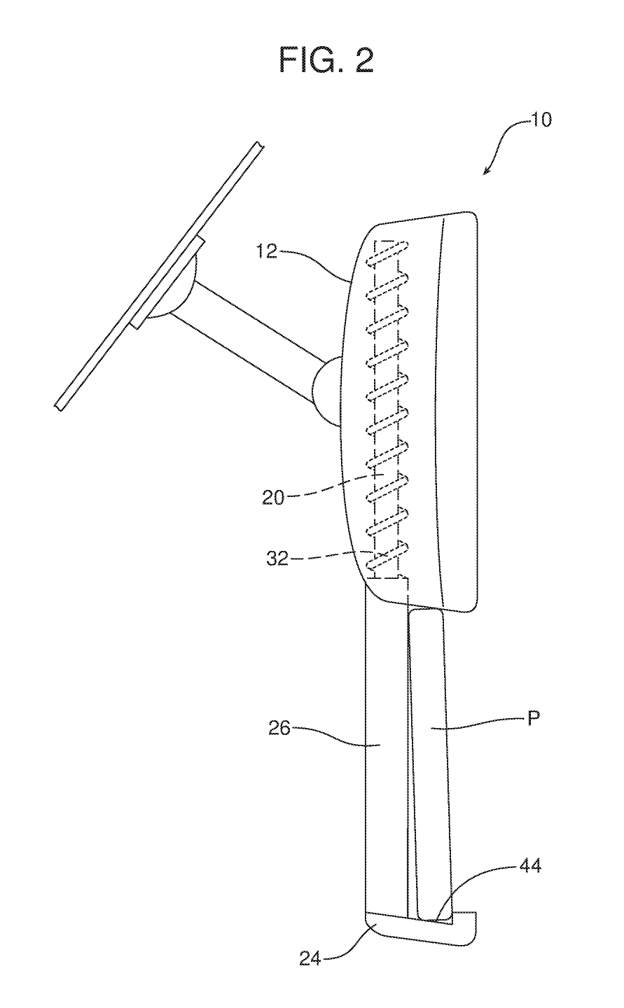

Reference is now made to the drawing FIGS. 1-4 illustrating the new and improved rearview mirror assembly 10. As illustrated, the rearview mirror assembly 10 includes a housing 12. The housing 12 may be made from any appropriate, lightweight material such as molded plastic or composite material. A mirror 14 is carried on the housing 12. The mirror 14 is utilized by the driver of the motor vehicle to view the roadway behind the motor vehicle through the rear window of the motor vehicle in a manner known in the art.

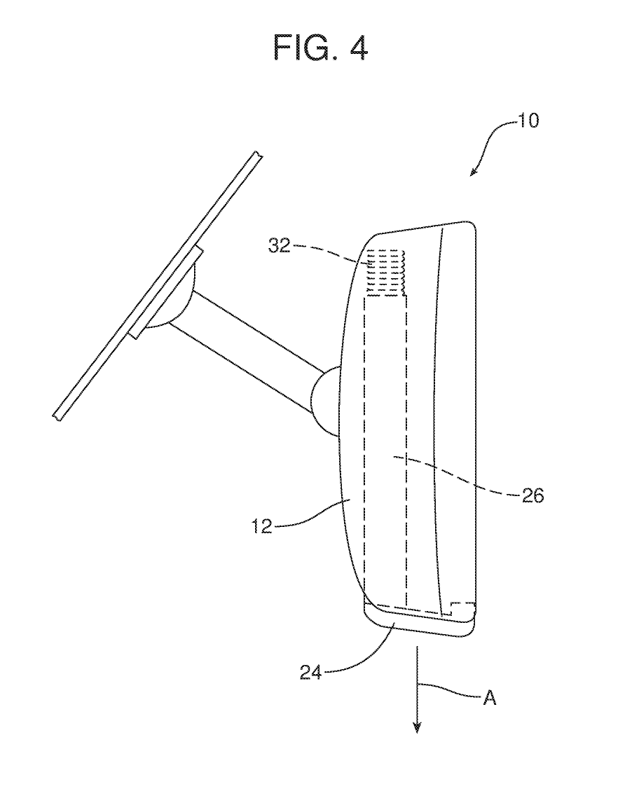

The rearview mirror assembly 10 also includes a clamping element, generally designated by reference numeral 16. The clamping element 16 is carried on the housing 12 and is displaceable between a stowed position at least partially concealed within the housing 12 as illustrated in FIG. 4 and a deployed position at least partially projecting from the housing as illustrated in FIGS. 1-3. When deployed, the clamping element 16 is adapted to hold an electronic device such as the smart phone P immediately below the mirror 14 where the display screen DS of the smart phone P may be viewed without diverting the driver's attention from the sight lines used to operate the motor vehicle.

As illustrated in FIGS. 1-4, the rearview mirror assembly 10 includes a guideway 18 that is carried on the housing 12. In the illustrated embodiment, the guideway 18 includes a first guide track 20 and a second guide track 22 in the form of cylindrical posts.

As should be further appreciated from reviewing FIGS. 1-4, the clamping element 16 includes a cradle 24, a first support 26 and a second support 28. The first support 26 slides along the first guide track 20 while the second support 28 slides along the second guide track 22.

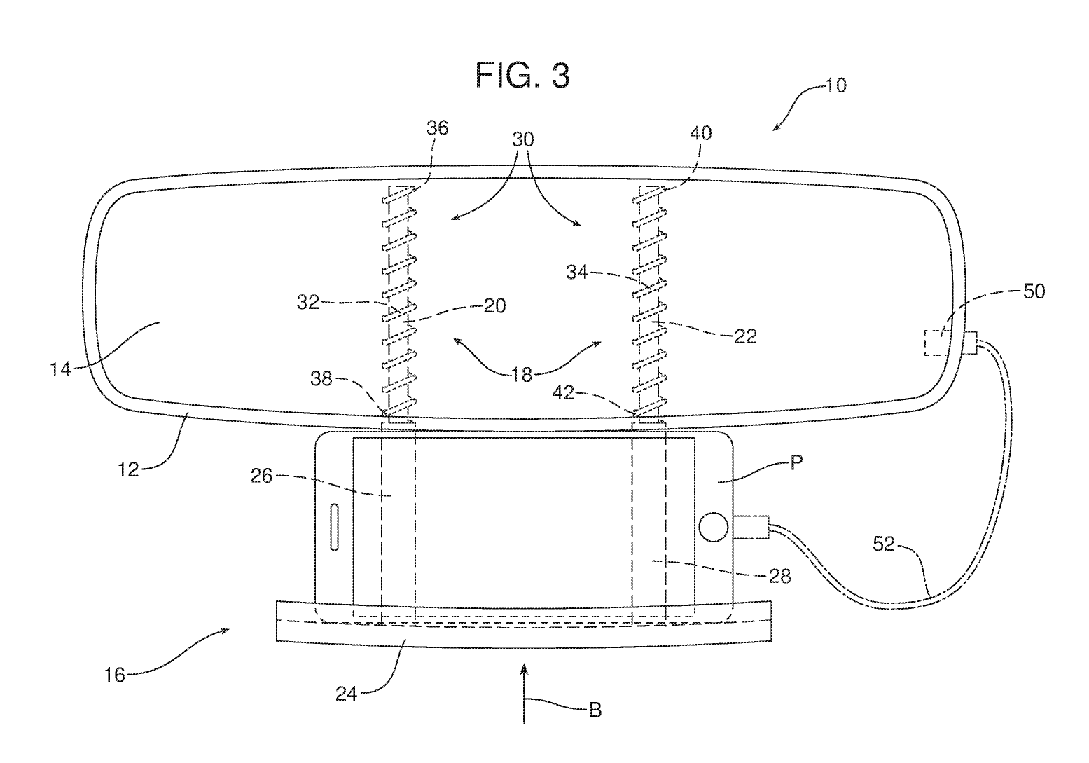

A biasing feature, generally designated by reference numeral 30 biases the clamping element 16 toward the stowed position illustrated in FIG. 3. In the illustrated embodiment the biasing feature 30 comprises a first tension spring 32 and a second tension spring 34. The first tension spring 32 is received over the first guide track 20 and has a first end 36 secured to the first guide track 20 and a second end 38 secured to the first support 26.

The second tension spring 34 is received over the second guide track 22. The second tension spring 34 has a third end 40 secured to the second guide track 22 and a fourth end 42 secured to the second support 28.

As illustrated in FIG. 4, when the clamping element 16 is in the stowed position, the cradle 24 forms the bottom portion of the housing 12. When one wishes to deploy the clamping element 16, one grasps the cradle 24 between the thumb and at least one finger and pulls downward in the direction of action arrow A to displace the clamping element 16 against the force of the biasing feature 30 until sufficient space is provided between the bottom of the housing 12 and the top of the cradle 24 to receive the smart phone P. The operator then inserts the lower edge of the smart phone P into the channel 44 formed in the cradle 24 while resting the back of the smart phone P against the supports 26,28 of the clamping element 16. The operator then releases the clamping element 16 allowing the biasing feature 30/first and second tension springs 32, 34 to bias the cradle 24 in the direction of action arrow B (see FIG. 3) until the smart phone P is captured between the cradle 24 and the bottom of the housing 12 beneath the mirror 14. Since the smart phone P is squeezed between the cradle 24 and the housing 12 by the biasing feature 30/first and second tension springs 32, 34, the smart phone P is securely held in position underneath the mirror 14 against foreseeable acceleration, deceleration and lateral forces generated during motor vehicle operation.

As further illustrated in FIG. 3, the rearview mirror assembly 10 may also include a USB port 50. In the illustrated embodiment, the USB port 50 is provided in the housing 12 adjacent the deployed cradle 24. A relatively short cable 52 functions to connect the USB port on the smart phone P with the USB port 50 carried on the housing 12. Advantageously, such a short cable 52 eliminates distractions associated with a longer cable and does not interfere with control switch ware and the operation of the motor vehicle.

When one wishes to remove the smart phone P from the cradle 24, one unplugs the cable 52 from the USB port 50, displaces the clamping element 16 downward in the direction of action arrow A so as to release the squeezing pressure on the smart phone P and then lifts the smart phone P from the channel 44 of the cradle 24. Upon release, the biasing feature 30/first and second tension springs 32, 34 return the clamping element 16 to the stowed position illustrated in FIG. 4 wherein the clamping element is at least partially concealed within the housing 12 of the rearview mirror assembly 10.

When closed, the bottom of the cradle 24 may fit flush with the housing 12 to create an aesthetically pleasing appearance.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A rear view mirror assembly, comprising:
a housing;
a mirror carried on said housing; and
a clamping element carried on said housing, said clamping element being displaceable between a stowed position at least partially concealed within said housing and a deployed position at least partially projecting from said housing.

2. The rear view mirror assembly of claim 1, further including a guideway carried on said housing.

3. The rear view mirror assembly of claim 2, wherein said guideway includes a first guide track and a second guide track.

4. The rear view mirror assembly of claim 3, wherein said clamping element includes a cradle, a first support and a second support.

5. The rear view mirror assembly of claim 4, wherein said first support slides along said first guide track and said second support slides along said second guide track.

6. The rear view mirror assembly of claim 5, further including a biasing feature biasing said clamping element toward said stowed position.

7. The rear view mirror assembly of claim 6, wherein said biasing feature comprises a first tension spring and a second tension spring.

8. The rear view mirror assembly of claim 7, wherein said first tension spring is received over said first guide track and said second tension spring is received over said second guide track.

9. The rear view mirror assembly of claim 8, wherein said first tension spring has a first end secured to said first guide track and a second end secured to said first support.

10. The rear view mirror assembly of claim 9, wherein said second tension spring has a third end secured to said second guide track and a fourth end secured to said second support.

11. The rear view mirror assembly of claim 10, further including a USB port carried on said housing.

12. The rear view mirror assembly of claim 11, wherein said cradle includes a channel.

13. The rear view mirror assembly of claim 1, wherein said clamping element includes a cradle.

14. The rear view mirror assembly of claim 1, further including a USB port.

15. The rear view mirror assembly of claim 14, wherein said USB port is carried on said housing.
